(19) United States
(12) Patent Application Publication
(10) Pub. No.: US 2010/0323074 A1
(43) Pub. Date: Dec. 23, 2010

(54) DEVICE FOR HEATING AND FOAMING MILK

(75) Inventors: Michael Fliegauf, Egerkingen (CH); Martin Frischknecht, Brittnau (CH)

Correspondence Address: VENABLE LLP, P.O. BOX 34385, WASHINGTON, DC, 20043-9998, US

(73) Assignee: Cafina AG, Hunzenschwil (CH)

(21) Appl. No.: 12/815,774

(22) Filed: Jun. 15, 2010

(30) Foreign Application Priority Data
Jun. 17, 2009 (DE) 10 2009 025 986.4

(51) Int. Cl. A23C 9/00; A23C 3/02; A23L 2/54

(52) U.S. Cl. 426/474; 99/453; 99/323.1

(57) ABSTRACT

A device for heating and foaming milk includes a steam-generating device to generate steam by heating water. The steam generating device has a steam outlet. A shut-off value is coupled to the steam outlet. A first line is coupled via the shut-off valve to the steam outlet of the steam-generating device so that steam can be discharged through the first line from the steam-generating device. The first line is selectively opened and closed with the aid of the shutoff valve. The first line has an outlet arranged to be submerged directly into a container which contains the milk to be foamed. A second line having an outlet is coupled to a pump to pump air into the second line. The outlet of the second line is arranged to be submerged separately and at a distance to the first line directly into the container holding the milk to be foamed, so that steam and air is supplied completely separate from each other during the heating and foaming of the milk.

### CROSS-REFERENCE TO RELATED APPLICATION

This application claims the priority of German Patent Application No. 10 2009 025 986.4, filed on Jun. 17, 2009, the subject matter of which is incorporated herein by reference in its entirety.

### BACKGROUND OF THE INVENTION

The invention relates to a device for heating and foaming milk, in particular used in a coffee machine. Such a device includes the following components: a steam-generating device designed to heat water for generating steam which is discharged through a first line from the steam-generating device, wherein this line can be opened and closed with the aid of a shutoff valve. The device further comprises a pump for pumping air into a second line.

A generic device for heating and foaming milk is known from the German patent document DE 44 45 436. According to the disclosure therein, air and steam as well as milk are mixed inside a mixing chamber and the foamed milk is then conducted into a container. International Patent Publication No. WO 2003/092458 discloses a different device for heating and foaming milk, for which milk and steam are combined inside a pumping device and are then pumped with the aid of this pumping device into a milk container.

However, the foam qualities that can be achieved with the above described devices are not satisfactory.

Starting with the generic prior art disclosed in the German patent document DE 44 45 436, it is an object of the present invention to provide an improved device for heating and foaming milk.

### SUMMARY OF THE INVENTION

The above and other objects are achieved according to the invention wherein there is provided, in one embodiment, a device for heating and foaming milk, comprising: a steam-generating device to generate steam by heating water, the steam generating device having a steam outlet; a shut-off value coupled to the steam outlet; a first line coupled via the shut-off valve to the steam outlet of the steam-generating device so that steam is dischargeable through the first line from the steam-generating device, wherein the first line is selectively opened and closed with the aid of the shutoff valve, and wherein the first line has an outlet arranged to be submerged directly into a container which contains the milk to be foamed; a second line having an outlet; a pump to pump air into the second line; wherein the outlet of the second line is arranged to be submerged separately and at a distance to the first line directly into the container holding the milk to be foamed, so that steam and air is supplied completely separate from each other during the heating and foaming of the milk.

According to a further aspect of the invention there is provided a method for operating a device for foaming and heating milk, which in one embodiment includes: conducting steam and air completely separate from each other into a container holding milk to heat and foam the milk.

The outlet opening of the first line is accordingly designed to be submerged directly into a container holding the foaming milk while the outlet of the second line is designed to be submerged directly into the container holding the foaming milk, but at a distance to the first line with respect to the fluid path, so that steam and air can be supplied separately during the heating and foaming of milk.

This results in a structural advantage as compared to the disclosures in German patent document DE 44 45 436 in that a mixing chamber can be dispensed with.

As compared to the disclosure in WO 2003/092458, a pumping device is not required to first mix the milk and steam exiting from the first and second lines, wherein this mixture must then be pumped into a container filled with milk.

In addition, there are a number of clear, method-technical advantages.

Furthermore, as compared to the disclosures in the DE 44 45 436 and WO 2003/092458, the present invention makes it possible to obtain milk foam which comes close to the “real” hand-foamed barista mixture that originated in Italy.

In particular when feeding in steam and air via the joint pumping device, in the manner as disclosed in WO 2003/092458, only a single outlet cross section is provided which is adapted to the steam-air mixture. If, on the other hand, only air without steam would be supplied via this cross section, it would result in insufficient flow speed and thus also in insufficient mixing of the air and milk.

As a result, the disclosure herein not only turns away from the generic prior art, but purposely also from the path described in WO 2003/092458 of initially mixing air and steam before these are conducted into the milk. Instead, milk and steam are conducted via separate lines directly into a container filled with milk to be foamed.

The disclosure herein furthermore also offers a number of other clear advantages as compared to the prior art. Thus, the air is supplied through a separate line from the steam line, independent of the state of the steam which is influenced among other things by density, saturation, amount, flow speed and the like.

As a result of supplying air and steam separately, it is furthermore easier to supply the respective optimum volume and/or optimum amount of the two media to the milk since a mutual influencing of the media does not have to be taken into account.

By using separate lines, the air and steam can furthermore be supplied at different times because of the separate outlet openings.

Providing a separate line for the air and steam additionally allows using surprisingly simple techniques for embodying the inflow zones (inflow plane and/or level) differently for the respective medium, so that the steam for heating up the milk, for example, is conducted deeper into the milk than the air for foaming it. This is not possible when using a single line for supplying the air and steam.

The outlet cross section and the embodiment of the outlet cross section for the respective air and steam feed line can be adapted easier to the individual medium as a result of having separate lines.

When using separate lines for air and milk, the air is supplied separately to the milk in a manner that is similar to the traditional foaming of the milk through the barista. The foam generated in this way closely resembles the desired foam produced in the traditional manner with a barista.

Owing to the separate feed line for air, the operation is also similar to that of a barista because the air is cooler and not heated by steam. The barista also transports normal (cool) environmental air into the milk, via a special handling of the steam distributor. As a result, the process of foaming is so-to-speak extended and a better foam quality can be achieved, e.g. a finer foam.

### DETAILED DESCRIPTION OF THE DRAWINGS

These and other features and advantages of the invention will be further understood from the following detailed description with reference to the accompanying drawings.

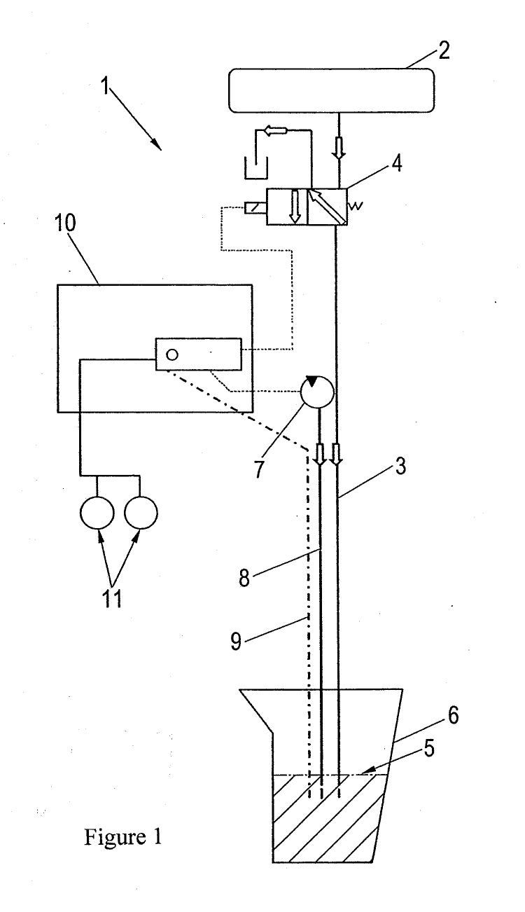

FIG. 1 is a schematic representation of the wiring diagram for a device 1 according to the invention for heating and foaming milk used in a coffee machine.

### DETAILED DESCRIPTION

FIG. 1 shows a device 1 for heating and foaming milk used in a coffee machine.

The device 1 comprises a steam-generating device which is designed to generate steam by heating water. The steam is discharged from the steam-generating device 2 through a first line 3 which can be opened and closed with the aid of a shutoff valve 4. The first line 3, which is a single or multi-part line in the axial line direction, is designed so that the outlet can be submerged directly into a container 6 that can be held or placed underneath the outlet and which contains the milk to be foamed.

In addition, the device 1 comprises a pump 7 for pumping air into a second single or multi-part line 8 in the axial line direction, wherein the outlet for this second line 8 is also designed such that it can be submerged directly into the container 6 holding the milk 5 to be foamed, but separately from the first line 3 with respect to the fluid path.

A temperature probe 9 is furthermore provided which can also be submerged into the container 6.

This temperature probe 9 is connected to a control device 10 which, in turn, is connected to the pump 7 and the steam shutoff valve 4.

The control device 10 preferably comprises a micro-controller (not shown herein) as well as and an input 11 for entering the control commands and, if applicable, also an output for displaying information.

Milk and steam are conducted separately into the milk, such that a particularly good foam quality is achieved.

The invention has been described in detail with respect to various embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. A device for heating and foaming milk, comprising:
a steam-generating device to generate steam by heating water, the steam generating device having a steam outlet;
a shut-off value coupled to the steam outlet;
a first line coupled via the shut-off valve to the steam outlet of the steam-generating device so that steam is dischargeable through the first line from the steam-generating device, wherein the first line is selectively opened and closed with the aid of the shutoff valve, and wherein the first line has an outlet arranged to be submerged directly into a container which contains the milk to be foamed;
a second line having an outlet;
a pump to pump air into the second line;
wherein the outlet of the second line is arranged to be submerged separately and at a distance to the first line directly into the container holding the milk to be foamed, so that steam and air is supplied completely separate from each other during the heating and foaming of the milk.

2. The device according to claim 1, further comprising a temperature probe submergible into the container.

3. The device according to claim 2, further comprising a control device connected to the temperature probe, the pump and the steam shutoff valve.

4. A method for operating a device for foaming and heating milk, comprising:
conducting steam and air completely separate from each other into a container holding milk to heat and foam the milk.
